(19) United States
(12) Patent Application Publication
(10) Pub. No.: US 2013/0340565 A1
(43) Pub. Date: Dec. 26, 2013

(54) BICYCLE CRANK SET

(71) Applicant: Ding-Jiun LIN, Taichung City (TW)

(72) Inventor: Ding-Jiun LIN, Taichung City (TW)

(73) Assignee: TIEN HSIN INDUSTRIES CO., LTD., Taichung City (TW)

(21) Appl. No.: 13/559,922

(22) Filed: Jul. 27, 2012

(30) Foreign Application Priority Data
Jun. 21, 2012 (TW) 101211951

(51) Int. Cl. B62M 3/00

(52) U.S. Cl. 74/594.2

(57) ABSTRACT

A bicycle crank set is comprising a crank having at least one support portion protruding therefrom, a first lateral surface, a second lateral surface opposite to the first lateral surface; a first chain wheel located at the first lateral surface and having a second through hole; a second chain wheel located at the second lateral surface and having at least one threaded hole; and a screw bolt inserted outward through the second through hole and then the first through hole to be engaged with the threaded hole. Accordingly, the bicycle crank set is structurally simple and convenient in assembly and the head of the screw bolt is hidden at the inner side of the crank set to be aesthetic in appearance.

### BACKGROUND OF THE INVENTION

1. Field of the Invention

The present invention relates generally to a crank set and more particularly, to an assembly structure of bicycle crank set.

2. Description of the Related Art

The crank set of the conventional multi-speed bicycle is formed of a crank and at least two chain wheels, two of which are a large sprocket and a small sprocket, respectively, wherein the former is mounted to the crank relative to the external side of the bicycle and the latter is mounted to the crank relative to the internal side of the bicycle. The crank is fastened with the small and large sprockets by a screw bolt and a screw nut. For example, as disclosed in FIG. 5 of U.S. Pat. No. 7,850,564, the crank includes at least two through holes corresponding to respective through holes of the sprockets; the screw nut is shaped like a sleeve and inserted through the crank and the sprockets outward from relatively close to the internal side of the bicycle and the screw bolt is screwed inward with the screw nut in such a way that the sprockets are fixed to the crank.

However, the screw nut is only tight fit with the crank and the through holes of the sprockets, so it is very difficult to fully prevent the screw nut from synchronic rotation while the screw bolt is turned. Since it is subject to trouble in assembly or disassembly, it additionally needs a packing member mounted between the screw nut and the through holes. In this way, the whole structure becomes more complex and the assembly difficulty increases as well. In addition, the head of the screw bolt is exposed directly on the external surface of the crank set relatively away from the bicycle to easily ruin the aesthetic appearance of the whole design of the crank set. Therefore, the conventional bicycle crank set needs further improvement.

### SUMMARY OF THE INVENTION

The primary objective of the present invention is to provide a bicycle crank set, which is structurally simple, convenience in assembly, and aesthetic in appearance.

The foregoing objective of the present invention is attained by the bicycle crank set composed of a crank, a first chain wheel, a second chain wheel, and a screw bolt. The crank includes a main body and at least one support portion extending outward from the main body. The support portion has a first lateral surface relatively close to the bicycle, a second lateral surface opposite to the first lateral surface, and a first through hole running through the first and second lateral surfaces. The first chain wheel is located at the first lateral surface and includes a second through hole corresponding to the first through hole. The second chain wheel is located at the second lateral surface and includes a threaded hole corresponding to the first through hole. The screw bolt includes a head portion and a body portion having a thread formed on a periphery thereof. The body portion is inserted through the second through hole, then the first through hole, and finally the threaded hole and the thread is engaged with the threaded hole.

In light of the structure mentioned above, only one single screw bolt is used for threadably locking the crank, the first chain wheel, and the second chain wheel, so the whole structure is relatively simple, both of the assembly and the disassembly are very convenient, and the head portion of the screw bolt is hidden at the inner side of the crank set to make the crank set aesthetic. Besides, the design of one single thread corresponding to one single threaded hole can secure the accuracy of the threadable locking.

In a preferred embodiment of the present invention, the length of the body portion is substantially equal to the sum of the length of the first and second chain wheels and the threaded hole.

In a preferred embodiment of the present invention, the end surface of the body portion and the external surface of the second chain wheel relatively away from the support portion are located on the same continuous surface. In this way, the screw bolt can avoid protrusion from the second chain wheel and be consistent with the whole crank set in appearance via surface treatment

In a preferred embodiment of the present invention, the continuous surface is a plane.

### BRIEF DESCRIPTION OF THE DRAWINGS

FIG. 1 is a front view of a preferred embodiment of the present invention.

FIG. 2 is a sectional view of a part of the preferred embodiment of the present invention.

### DETAILED DESCRIPTION OF PREFERRED EMBODIMENTS

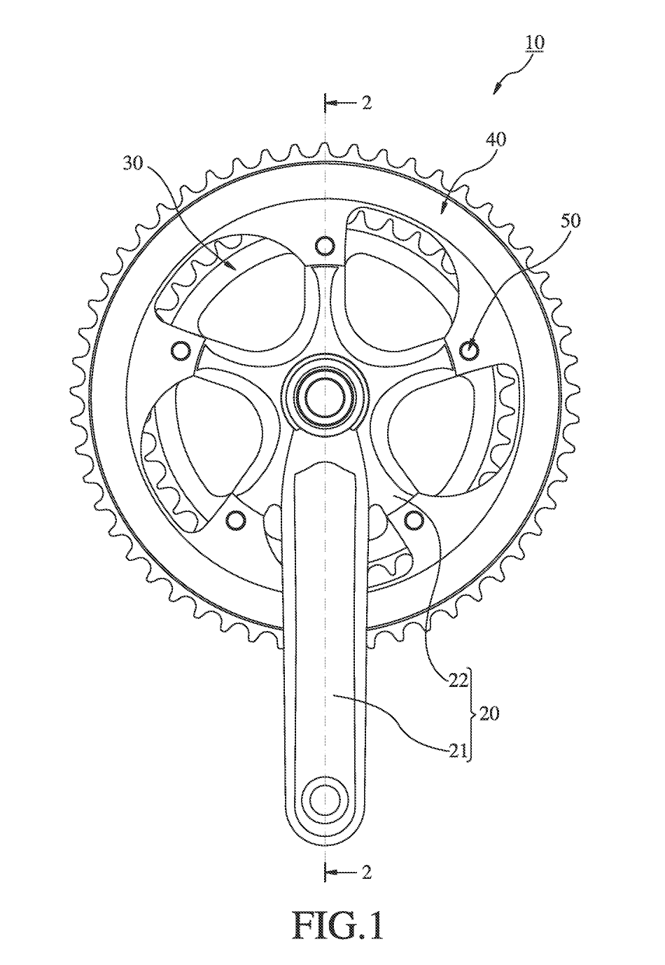

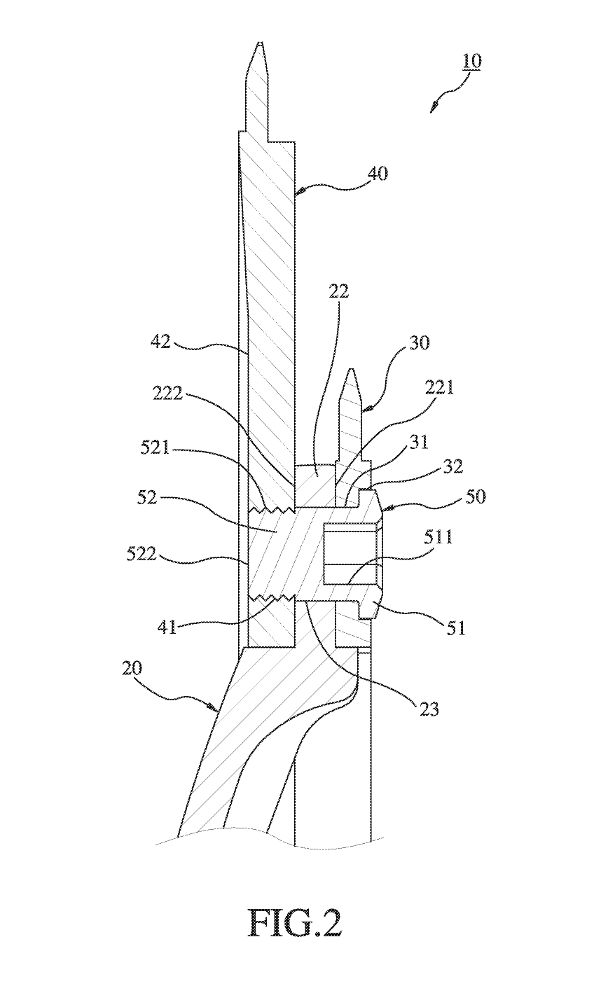

Referring to FIGS. 1-2, a bicycle crank set 10 to be mounted to a bicycle (not shown) in accordance with a preferred embodiment of the present invention is comprising a crank 20, a first chain wheel 30 mounted to one of two sides of the crank 20, a second chain wheel 40 mounted to the other side of the crank 20, and a plurality of screw bolts 50. The detailed descriptions and operations of these elements as well as their interrelations are recited in the respective paragraphs as follows.

The crank 20 includes a main body 21 and at least one support portion 22 extending outward from the main body 21. The at least one support portion 22 is five in number in this embodiment. Each of the support portions 22 includes a first lateral surface 221 close to the bicycle, a second lateral surface 222 opposite to the first lateral surface 221, and a first through hole 23 running through the first and second lateral surfaces 221 and 222.

The first chain wheel 30 is mounted to the first lateral surface 221 and includes five second through holes 31 corresponding to the five first through holes 23, respectively, and a plurality of concavities 32 each surrounding the corresponding second through hole 31 and relatively close to an inner side of the bicycle.

The second chain wheel 40 is mounted to the second lateral surface 222 and includes five threaded holes 41 corresponding to the five first through holes 23. The diameter of the second chain wheel 40 is larger than that of the first chain wheel 30.

Each of the screw bolts 50 includes a head portion 41 and a body portion 52. Each of the head portions 41 is larger than the corresponding body portion in diameter and has a tool insertion hole 511 recessed therefrom. Each of the body portions 52 has a thread 521 formed on a periphery thereof and is substantially equal to the sum of the corresponding first through hole 23, the corresponding second through hole 31, and the corresponding threaded hole 41 in length.

In light of the structure mentioned above, the user can insert each of the screw bolts 50 into the corresponding threaded hole 41 by passing the corresponding body portion 52 inward through the corresponding second through hole 31 and the corresponding first through holes 23 in order, and then insert a hand tool (not shown) into the corresponding tool insertion hole 511 to turn the screw bolt 50 in such a way that the corresponding thread 521 is engaged with the corresponding threaded hole 41. In the meantime, the corresponding head 51 is positioned in the corresponding concavity 32 to further thread ably fix the first and second chain wheels 30 and 40 to two sides of the corresponding support portion 22 of the crank 20, respectively. Therefore, the whole assembly is quick.

In the present invention, the thread 521 is engaged with the corresponding threaded hole 41 and none of any thread is formed on an internal peripheral wall of the corresponding first through hole 23 or the corresponding second through hole 31, so discrepancy of thread start angle can be avoided while one thread corresponds to two threaded holes and more to secure the accuracy of the threadable locking. However, the aforesaid thread formed on the internal peripheral wall of the corresponding first or second through hole is not excluded from the present invention but the interchangeable equivalent falling within the scope of the present invention.

In addition, as shown in FIG. 2, an end surface 522 of the body portion 52 and an external surface 12 of the second chain wheel 40 relatively away from the support portion 22 are located on the same continuous plane, so they can become consistent in appearance after a surface treatment without looking like protrusive.

Although the present invention has been described with respect to a specific preferred embodiment thereof, it is in no way limited to the specifics of the illustrated structures but changes and modifications may be made within the scope of the appended claims.

What is claimed is:

1. A bicycle crank set for being mounted to a bicycle, comprising:
a crank having a main body and at least one support portion extending outward from the main body, the at least support portion having a first lateral surface relatively close to the bicycle, a second lateral surface opposite to the first lateral surface, and a first through hole running through the first and second lateral surfaces;
a first chain wheel located at the first lateral surface and having a second through hole corresponding to the first through hole;
a second chain wheel located at the second lateral surface and having a threaded hole corresponding to the first through hole; and
a screw bolt having a head portion and a body portion, the body portion having a thread formed on a periphery thereof, the body portion passing through the second through hole, the first through hole, and the threaded hole in order, and then the thread being engaged with the threaded hole, the body portion being substantially equal in length to the sum of the second through hole, the first through hole, and the threaded hole.

2. The bicycle crank set as defined in claim 1, wherein the body portion comprises an end surface and the second chain wheel comprises an external surface relatively away from the support portion, the end surface and the external surface being located the same continuous surface.

3. The bicycle crank set as defined in claim 2, wherein the continuous surface is a plane.

4. The bicycle crank set as defined in claim 1, wherein the head portion of the screw bolt is larger than the body portion in diameter and the first chain wheel comprises a concavity formed relatively close to an inner side of the bicycle and surrounding the second through hole for receiving the head portion.
